(19) United States
(12) Patent Application Publication
(10) Pub. No.: US 2004/0028350 A1
(43) Pub. Date: Feb. 12, 2004

(54) Transceiver

(75) Inventors: Karl Gerdom, Lubbecke (DE); Jens Krause, Rahden (DE); Carsten Marheine, Lubbecke (DE)

Correspondence Address: Norman P. Soloway, HAYES SOLOWAY P.C., 130 W. Cushing Street, Tucson, AZ, 85701, US

(73) Assignee: HARTING Electro-Optics GmbH & Co., KG

(21) Appl. No.: 10/631,296

(22) Filed: Jul. 31, 2003

(30) Foreign Application Priority Data
Aug. 6, 2002 (DE) 202 12 087.2

(51) Int. Cl. G02B 6/42; H04B 10/00

(52) U.S. Cl. 385/88; 398/135

(57) ABSTRACT

A transceiver comprises a conductor foil carrying an opto-electronic component, and a plug socket into which an optical waveguide plug connector can be inserted such that the optical waveguide of the optical waveguide plug connector is opposite the opto-electronic component. An plug section is formed by an end section of the conductor foil and is adapted to be connected with a complementary plug. The signal path from said plug section to said opto-electronic component has a matched impedance.

### TECHNICAL FIELD

The invention relates to a transceiver which can be attached to a base card (backplane) and into the one side of which an optical waveguide plug connector can be inserted, and into the other side an affiliated card.

### BACKGROUND OF THE INVENTION

The transceiver serves for converting electric signals, coming from a circuitry on the affiliated card, into optical signals which are coupled into the optical waveguide of the optical waveguide plug connector, and vice versa. For conversion of the signals there is used an opto-electronic component in the transceiver, in particular a VCSEL or a PIN diode. For achieving the desired high signal transmission rates, it is of importance that the optical waveguide of the optical waveguide plug connector is positioned with the highest possible precision relative to the opto-electronic component or optical transducer.

### BRIEF SUMMARY OF THE INVENTION

According to the invention, a transceiver comprises a conductor foil carrying an opto-electronic component, and a plug socket into which an optical waveguide plug connector can be inserted such that the optical waveguide of the optical waveguide plug connector is opposite the opto-electronic component. An plug section is formed by an end section of the conductor foil and is adapted to be connected with a complementary plug. The signal path from said plug section to said opto-electronic component has a matched impedance. This allows particularly high signal transmission rates. This is supported by the signal path in the conductor foil being provided only on one side thereof, i.e. without vias from one side to the other.

According to a preferred embodiment, a spacer is provided which serves as a stop for the optical waveguide plug connector. It is ensured by the spacer that the optical waveguide of the optical waveguide plug connector is set to the correct position relative to the opto-electronic component.

According to the preferred embodiment provision is made that the spacer is a sealing frame arranged in a region of the opto-electronic component. The sealing frame can be produced at low cost and serves at the same time as a limit for an optically transparent material in which the opto-electronic component will be encapsulated.

According to the preferred embodiment provision is made that the sealing frame is arranged directly on the conductor foil. This minimizes the tolerances of the construction and enhances the precision with which the optical waveguide will be positioned relative to the opto-electronic component.

According to the preferred embodiment provision is made that at least part of the interior of the sealing frame is filled with a castable optically transparent material. The optical signals are directly coupled into the optical waveguide of the optical waveguide plug connector right through the optically transparent material, and transferred from the waveguide to the opto-electronic component without the need of providing mirrors, lenses, waveguides or fibers in the transceiver.

According to the preferred embodiment of the invention provision is made that an overflow edge is provided, in particular in one piece with the sealing frame, which defines the level of the optically transparent material in the interior of the sealing frame. The overflow makes it possible to determine the level of the optically transparent material at minimum expense, by filling a sufficient amount of an optically transparent, free-flowing and curable material during production into the area encompassed by the sealing frame. Any excess material readily flows over the overflow edge acting as a barrier and will be discharged from the area encompassed by the sealing frame until the stream of material tears apart, so that there will be produced a precisely defined material level. A collecting chamber can be provided for the excess material. In case the flowability of the optically transparent, liquid material is not sufficient, it may be liquefied by heating. Using the overflow edge or barrier makes it possible to do away with a precise and, hence, expensive dosage of the used volume of the optically transparent material.

Assembly of the transceiver can be facilitated if the sealing frame is provided with at least one positioning hole allowing a positioning relative to other components of the transceiver.

According to the preferred embodiment provision is made that the opto-electronic component is arranged on a leadframe made of metal and acting as a heat sink. This makes it possible to effectively carry away the generated dissipated heat. There may further be provided a housing which is realized as a heat sink. The latter measure likewise helps to carry away the dissipated heat, reduces the size of the component and allows a higher packaging density of the transceiver in the electric or electronic device.

The sealing frame is preferably provided with at least one guide hole for a guide pin of the optical waveguide plug connector. This makes it possible to arrange the optical waveguide plug connector and, hence, the optical waveguide received therein, at high precision relative to the opto-electronic component which is arranged on the leadframe. The sealing frame likewise has at least one guide hole for the guide pin of the optical waveguide plug connector, through which the guide pin of the optical waveguide plug connector can be inserted into the leadframe. In order to facilitate the inserting of the optical waveguide plug connector, the guide hole of the sealing frame is provided with a lead-in surface.

The conductor foil can have further electronic components arranged on it, for instance a driver/amplifier chip which is directly bonded with the opto-electronic component for obtaining a short length of the bond wire. It is also possible to provide additional control elements by means of which operating parameter of the transceiver can be adjusted.

In order to obtain a run of the bond wire which is flat and optimized for the transmission of RF signals, and in order to obtain a minimized bond wire length, provision is made that the level of the bond pads of the opto-electronic component is located above the level of the bond pads of the driver/amplifier chip and that the level of the bond pads of the driver/amplifier chip is located above the level of the bond pads of the conductor foil. Moreover, a wedge-wedge wire bonding process using a bond wire of gold is used for bonding.

It is preferably provided for that the conductor foil has a rigid structure in the region of the opto-electronic component and in the region of the plug section. This facilitates its installation.

There may further be provided for that the plug section of the conductor foil is mounted so as to be displaceable. This allows a compensation of tolerances upon attaching the affiliated card.

### BRIEF DESCRIPTION OF THE DRAWINGS

FIG. 1 shows an exploded view of a transceiver according to the invention including an optical waveguide plug connector and an affiliated card;

FIG. 2 shows a perspective view of the transceiver when assembled;

FIG. 3 shows a cross-section through the transceiver with the optical waveguide plug connector inserted;

FIG. 4 shows on an enlarged scale the detail IV of FIG. 3; and

FIG. 5 shows in a perspective, broken view the end section of the conductor foil provided with the opto-electronic component, in a perspective view.

### DETAILED DESCRIPTION OF THE PREFERRED EMBODIMENTS

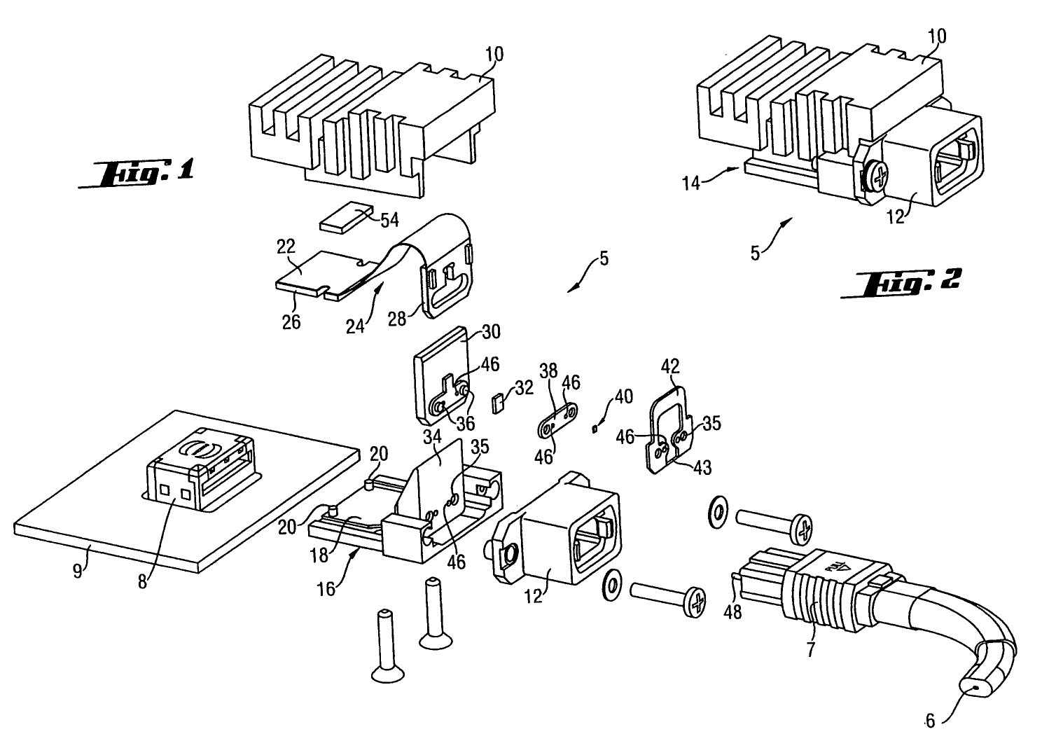

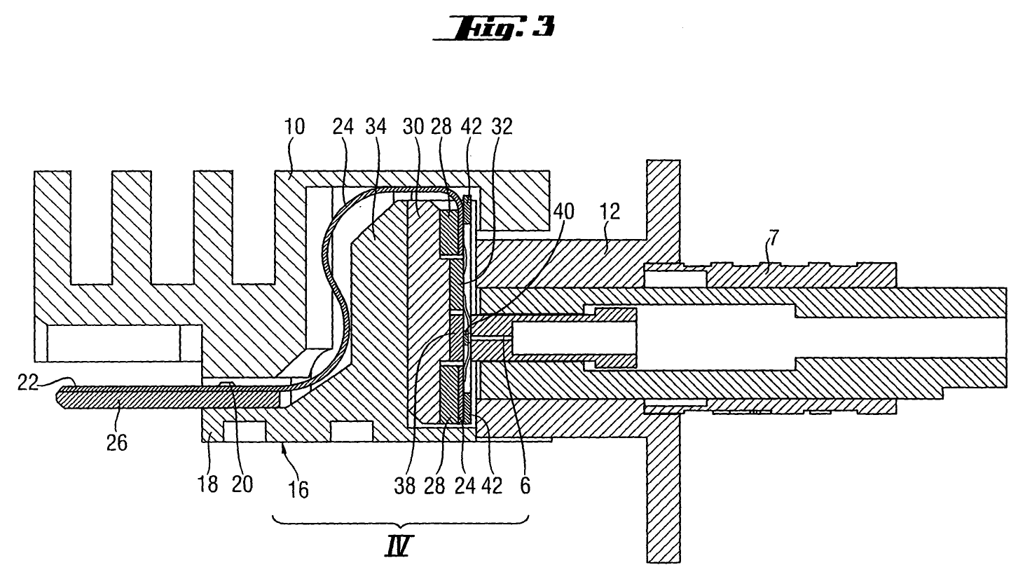

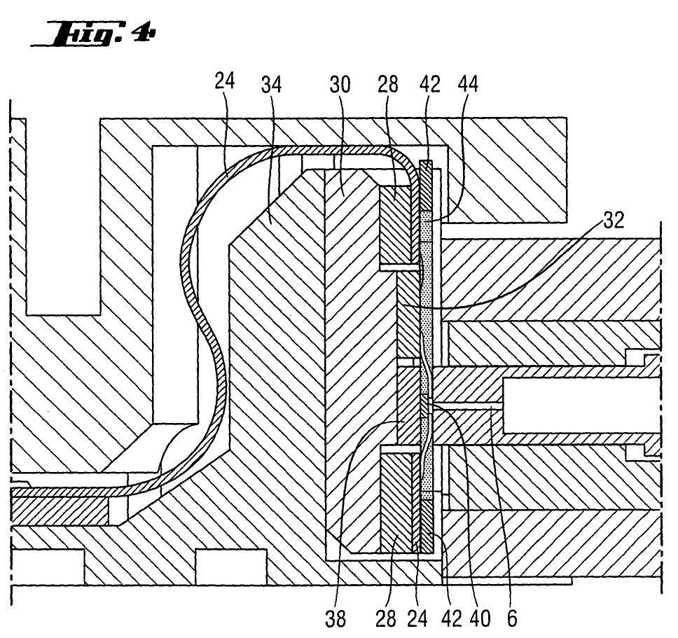

In FIGS. 1 and 2 there is shown a transceiver 5 which comprises a housing 10, a plug socket 12 and an plug section 14. The transceiver is provided for being mounted to a (not illustrated) rear wall of an electric or electronic device. An optical waveguide plug connector 7 (see FIG. 1) having an optical waveguide 6 can be inserted into the plug socket 12, which connector 7 is realized as a MT plug, in particular. A complementary plug connector 14 provided on an affiliated card 9 can be attached to the plug section 14. The affiliated card is provided for being inserted into the electric or electronic device and for being connected with the optical waveguide plug connector 7 via the transceiver.

The transceiver 5 has a base plate 16 which may be made of metal. The plug socket 12 is screwed to the base plate 16 by means of two bolts.

At its end opposite the plug socket 12, the base plate 16 is provided with a support plate 18 on which two positioning studs 20 are provided. An end section 22 of a conductor foil 24 is placed on the support plate 18 and arrested there; to this end there are provided two notches for the positioning studs 20. The end section 22 of the conductor foil 24 forms the plug section 14 of the transceiver 5 and has a rigid construction. A reinforcement plate 26 is provided to this end. In this way the end section 22 of the conductor foil 24, together with the reinforcement plate 26, can project from the base plate 16 freely beyond the support plate 18, so that the complementary plug connector 8 can be slipped onto the end section 22.

The opposite end of the conductor foil 24 likewise has a rigid construction, by providing a reinforcement frame 28 which has a cut-out. The reinforcement frame 28 is placed on a leadframe 30, with a driver/amplifier chip 32 being arranged in the region of the cut-out of the reinforcement frame 28. The leadframe 30 is supported by an abutment plate 34 of the base plate 16. For precisely positioning the leadframe 30, the latter is provided with two positioning pins 36 which project on both sides of the leadframe 30 an engage into positioning holes 35 of the abutment plate 34 on that side which is not visible in the illustration of FIG. 1.

Arranged on the leadframe 30 of the driver/amplifier chip 32 is a leadframe 38 for an opto-electronic component 40. In particular, the opto-electronic component may be a VCSEL or a PIN diode. The leadframe 38 is provided with openings which are engaged by the positioning pins 36. In this way the leadframe 38 of the optical transducer is precisely positioned.

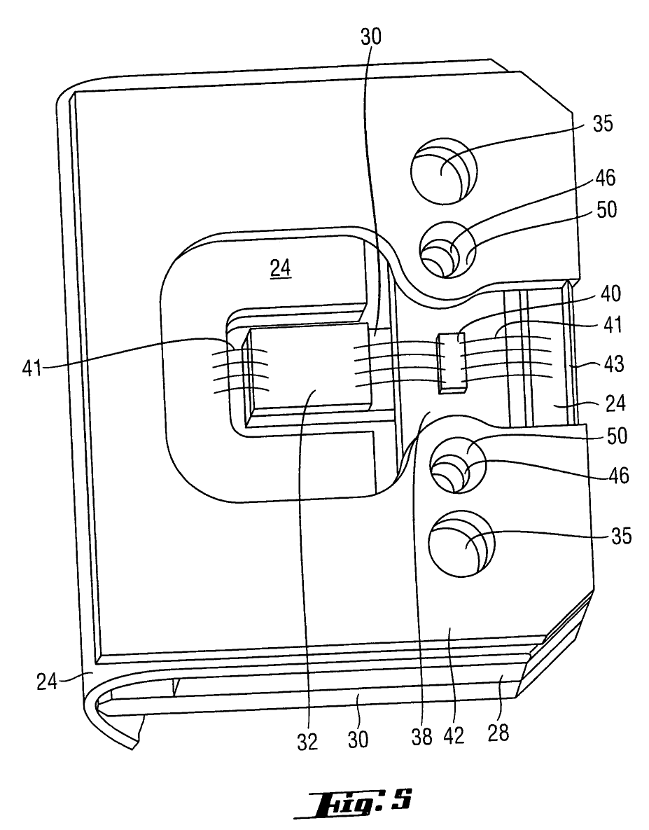

The (not shown) conductor tracks of the conductor foil 24, the driver/amplifier chip 32 and the opto-electronic component 40 are connected with each other by wire bonding, to be precise by wedge-wedge bonding using a gold wire. Wedge-wedge bonding results in short, flatly running bond wires 41 (see FIG. 5) which are of advantage for RF signal transmission. As can be seen in particular in FIG. 4, the level of the bond pads of the conductor tracks of the conductor foil 24 is the lowermost one. Slightly higher lies the level of the bond pads of the driver/amplifier chip 32. Significantly above this level is the level of the bond pads of the opto-electronic component 40.

The driver/amplifier chip 32 and the opto-electronic component 40 are surrounded by a sealing frame 42. This frame is made of plastic, rests directly on the conductor foil 24 and has two positioning holes 35 into which the positioning pins 36 can engage. The sealing frame has a precisely determined thickness and has two functions. On the one hand, it serves as a spacer, because it serves as a stop for the optical waveguide plug connector 7 when being inserted into the plug socket 12. Due to its thickness, the sealing frame 42 determines the distance between the optical waveguide of the optical waveguide plug connector 7 and the opto-electronic component 40. On the other hand, the sealing frame 42 serves as a limit for an optically transparent material 44 (indicated by dots in FIG. 4) in which the driver/amplifier chip 32, the opto-electronic component 40 as well as the bond wires and bond pads are encapsulated.

For the high quality of signal transmission between the optical waveguide of the optical waveguide plug connector 7 and the opto-electronic component 40 it is required that the thickness of the optically transparent material 44 is precisely adjusted, as differing thicknesses of the material would result in varying transmission characteristics. In order to achieve a constant and precisely defined filling level, there is provided an overflow edge 43 which is made in one piece with the sealing frame 42. This makes it possible during encapsulating to fill in a volume of the optically transparent material into the sealing frame which is a comparably roughly measured volume. The only condition is that the filled-in volume is larger than that one which is necessary for a complete and correct encapsulation. The excess volume will then be discharged from the sealing frame over the overflow edge until the material tears apart at the overflow edge once the desired level in the interior of the sealing frame is reached. Discharging of the material is finished, and the material left within the sealing frame may be cured now.

In practice it may be made provision that the driver/amplifier chip 32 is covered with an optically non-transparent material, for instance a black plastic material. Light will be prevented from shining onto the chip. This black plastic material has a very low viscosity, so that it does not spread in the interior of the sealing frame. Subsequently, the optically transparent material can be filled into the sealing frame so that it spreads therein and fills the interior space up to the level predetermined by the overflow edge 43.

Two guide holes 46 are provided in the sealing frame 42, in the leadframes 38 and 30 as well as in the abutment plate 34; these holes can be engaged by two guide pins 48 provided on the optical waveguide plug connector 7. Two lead-in surfaces 50 are provided round the guide holes 46 (see in particular FIG. 5), in order to facilitate the engaging of the guide pins 48 in the guide holes 46 during insertion of the optical waveguide plug connector 7 into the plug socket 12.

During assembly the conductor foil 24 is placed on the base plate 16. When the housing 10 is mounted, the end section 22 of the conductor foil 24 together with the reinforcement plate 26 will be pressed against the support plate 18. An interposed pressure plate 54 made of an elastic material can be used for this. Together with the reinforcement frame 28, the section of the conductor foil 24 provided with the opto-electronic component 40 is pressed against the abutment plate 34 by the plug socket 12.

As can be imagined with the aid of FIG. 1, the optical waveguide plug connector 7 and the complementary plug connector 8 are inserted into the transceiver 5 (and pulled away from it) along the same direction. This is in particular due to the fact that the two end sections of the conductor foil 24 are arranged at right angles to each other. Accordingly, the opto-electronic component 40 is arranged perpendicularly to the affiliated card 9, and the optical waveguide plug connector 7 can be inserted into the base card.

1. A transceiver comprising a conductor foil carrying an opto-electronic component, a plug socket into which an optical waveguide plug connector can be inserted such that an optical waveguide of said optical waveguide plug connector is opposite said opto-electronic component, an plug section which is formed by an end section of said conductor foil and adapted to be connected with a complementary plug, wherein a signal path from said plug section to said opto-electronic component has a matched impedance.

2. The transceiver according to claim 1, wherein a spacer serving as a stop for said optical waveguide plug connector is provided.

3. The transceiver according to claim 2, wherein said spacer is a sealing frame arranged in a region of said opto-electronic component.

4. The transceiver according to claim 3, wherein said sealing frame is arranged on said conductor foil.

5. The transceiver according to claim 3, wherein at least part of an interior of said sealing frame is filled with a castable optically transparent material.

6. The transceiver according to claim 5, wherein an overflow edge is provided which defines a level of said optically transparent material in said interior of said sealing frame.

7. The transceiver according to claim 3, wherein said sealing frame is provided with at least one positioning hole facilitating a positioning relative to other components of said transceiver during assembly.

8. The transceiver according to claim 3, wherein said sealing frame is provided with at least one guide hole for a guide pin of said optical waveguide plug connector.

9. The transceiver according to claim 8, wherein said guide hole is provided with a lead-in surface.

10. The transceiver according to claim 1, wherein said opto-electronic component is arranged on a leadframe made of metal and acting as a heat sink.

11. The transceiver according to claim 10, wherein said leadframe is provided with at least one guide hole for a guide pin of said optical waveguide plug connector.

12. The transceiver according to claim 1, wherein a driver/amplifier chip is provided which is directly bonded with said opto-electronic component.

13. The transceiver according to claim 12, wherein a level of bond pads of said opto-electronic component is located above a level of bond pads of said driver/amplifier chip.

14. The transceiver according to claim 13, wherein said level of said bond pads of said driver/amplifier chip is located above a level of bond pads of said conductor foil.

15. The transceiver according to claim 14, wherein a wedge-wedge wire bonding process is used for bonding.

16. The transceiver according to claim 15, wherein a bond wire is made of gold.

17. The transceiver according to claim 1, wherein said opto-electronic component is arranged at right angles to said plug section of said conductor foil.

18. The transceiver according to claim 1, wherein a housing is provided which is realized as a heat sink.

19. The transceiver according to claim 1, wherein additional control elements are provided by means of which operating parameter of said transceiver can be adjusted.

20. The transceiver according to claim 1, wherein said conductor foil has a signal path only on one side thereof.

21. The transceiver according to claim 3, wherein said conductor foil has a rigid structure in said region of said opto-electronic component.

22. The transceiver according to claim 1, wherein said conductor foil has a rigid structure in a region of said plug section.

23. The transceiver according to claim 1, wherein said plug section is mounted so as to be displaceable.
